(19) United States
(12) Patent Application Publication
(10) Pub. No.: US 2015/0274549 A1
(43) Pub. Date: Oct. 1, 2015

(54) QUARTZ TUBE SOCKET AND OPEN CHANNEL-TYPE UV DISINFECTION SYSTEM HAVING THE SAME

(71) Applicant: NEOTEC LTD., Gyeongsangbuk-do (KR)

(72) Inventors: Woo-Chul HWANG, Seoul (KR); Hyo-Sun KIM, Seoul (KR)

(21) Appl. No.: 14/638,773

(22) Filed: Mar. 4, 2015

(30) Foreign Application Priority Data
Mar. 26, 2014 (KR) 10-2014-0035399
Jul. 29, 2014 (KR) 10-2014-0096487

(51) Int. Cl. C02F 1/32

(52) U.S. Cl. CPC C02F 1/325; C02F 2201/322; C02F 2201/3227

(57) ABSTRACT

Disclosed is a quartz tube socket mounted to an open channel-type UV disinfection system and coupled to a quartz tube having one end portion, the quartz tube socket having one side coupled to an electric cable end. The quartz tube socket includes a lamp socket fixing handle coupled to the electric cable end at the other side of the quartz tube socket, a sealing fixture fitted around and coupled to one side of the lamp socket fixing handle, an O-ring fitted around the sealing fixture, a frame clamp nut fitted around the sealing fixture after the O-ring, a sleeve stopper fitted around the sealing fixture after the frame clamp nut, an O-ring fitted around the sealing fixture after the sleeve stopper, a V-sealing installed at one side end of the sealing fixture, a backup ring installed after the V-sealing, a sealing collar installed after the backup ring, a V-sealing fitted after the sealing collar, a backup ring fitted and installed after the V-sealing, and a lamp base socket housing fitted around and coupled to an end of the lamp socket fixing handle.

### CROSS-REFERENCE TO RELATED APPLICATIONS

The present application claims priorities from Korean Patent Application Nos. 10-2014-0035399 filed on Mar. 26, 2014 and 10-2014-0096487 filed on Jul. 29, 2014, which are incorporated herein by reference in their entirety.

### BACKGROUND OF THE INVENTION

1. Field of Invention

The present invention relates to a quartz tube socket installed for sterilization at sewage and wastewater disposal facilities and other disposal facilities for producing recycled (or re-created) water, and an open channel-type UV disinfection system having the same.

2. Description of the Related Art

Generally, an open channel-type UV disinfection system includes a plurality of UV lamps, a quartz tube for protecting the lamps at a support frame, and a socket for supplying power to the UV lamps and preventing water leakage into the quartz tube, thereby sterilizing water flowing in a channel.

In order to sterilize sewage, wastewater or recycled (or re-created) water having low transmittance with respect to UV, a plurality of lamps should be arranged at small intervals. Therefore, the lamps are arranged at small intervals, the channel has a small width, and a large amount of water is supplied to the relatively narrow channel. For this reason, a high speed fluid flow occurs in the open channel where the channel-type UV disinfection system is installed, thereby forming a turbulent flow instead of a laminar flow. The turbulent fluid showing such an irregular flow speed applies vibrations and bending moments to the quartz tube mounted at the socket of the UV disinfection system, which causes troubles. In addition, the open channel-type UV disinfection system creates a disinfection dead zone due to its structural properties, which may result in insufficient disinfection.

Backgrounds in relation to the present invention may be seen from FIGS. 1 to 3 which show a conventional UV disinfection system.

FIG. 1 shows a configuration of the conventional open channel-type UV disinfection system, FIG. 2 (a) is an assembled cross-sectional view showing a quartz tube socket applied to the conventional open channel-type UV disinfection system, FIG. 2 (b) is an exploded view showing the quartz tube socket applied to the conventional open channel-type UV disinfection system, and FIG. 3 is a cross sectional view showing a quartz tube body applied to the conventional open channel-type UV disinfection system.

In FIG. 1, the conventional open channel-type UV disinfection system includes a plurality of ‘⊂’-shaped wiper ring brackets 430 at both sides of a wiper frame 440 of a quartz tube cleaning system 400. The wiper ring 420 is inserted into and supported by the ‘⊂’-shaped wiper bracket 430. Here, the ‘⊂’-shaped wiper ring bracket 430 is coupled to the wiper frame 440 having an H shape and supported by a plurality of coupling units using bolts and nuts. Holes are formed in upper and lower portions of the wiper ring bracket so that upper and lower sides of the wiper ring may be inserted therein. In the conventional UV disinfection system configured above, since a quartz tube 410 may be easily attached to or detached from a side of the UV disinfection system, the quartz tube 410 may be easily maintained and repaired. In addition, the quartz tube cleaning system 400 employs a motor, and as the motor 500 rotates clockwise or counterclockwise, a drive screw 460 linked to the motor rotates clockwise or counterclockwise. In addition, as the drive screw 460 rotates clockwise or counterclockwise, the drive nut 470 moves the cleaning system from side to side in a length direction of the quartz tube. Moreover, a top guide rail 480 and a bottom guide rail 490 are provided at upper and lower portions of the conventional UV disinfection system to guide the quartz tube cleaning system 400 so as to be fixedly coupled to side supports 485 and 486 at both ends. As the motor 500 rotates, the drive screw 460 connected to the motor using a coupling unit also rotates, and the rotation of the drive screw 460 causes the drive nut 470 to move from side to side and the wiper ring 420 installed at the wiper frame to clean the quartz tube 410. In order to prevent vibration, deviation from a track or the like generated when the cleaning system 400 moves from side to side by means of the drive nut 470 as described above, the top guide rail 480 and the bottom guide rail 490 are provided at the upper and lower portions, thereby guiding the cleaning system from side to side.

FIG. 2 (a) is a cross-sectional view showing a quartz tube socket of a conventional open channel-type UV disinfection system. In a quartz tube socket applied to the conventional open channel-type UV disinfection system shown in FIG. 2 (a), a cable connector 501 of a cable end 502 is coupled to one end of a lamp socket fixing handle 503. In addition, a sealing fixture 504 is fitted around and coupled to the lamp socket fixing handle 503, and an O-ring 505, a frame clamp nut 506 and a sleeve stopper 507 are fitted around and coupled to the sealing fixture 504. Moreover, the O-ring 505 is fitted around and coupled to the sealing fixture 504, and a V-sealing 508, a sealing collar 509 and a V-sealing 508 are also fitted around and coupled to the lamp socket fixing handle 503 in this order. In addition, a lamp base socket housing 511 is fitted around and coupled to an end of the lamp socket fixing handle 503, and a UV lamp socket 513 is provided inside the lamp base socket housing 511. Moreover, a quartz tube socket bracket 488 provided at the side support 486 is interposed between the O-ring 505 and the fixing clamp nut 506.

FIG. 2 (b) is an exploded view showing the lamp socket fixing handle 503, the sealing fixture 504, the frame clamp nut 506, the sleeve stopper 507, the lamp base socket housing 511 and the like of the quartz tube socket of the conventional UV disinfection system.

FIG. 3 is a cross-sectional view showing a quartz tube body applied to the conventional open channel-type UV disinfection system. In FIG. 3, the cable connector 501 of the cable end 502 is coupled to the lamp socket fixing handle 503, and the sealing fixture 504 is fitted around and coupled to the lamp socket fixing handle 503. In addition, the O-ring 505, the frame clamp nut 506 and the sleeve stopper 507 are fitted around and coupled to the sealing fixture 504. In addition, the O-ring 505 is fitted around and coupled to the sealing fixture 504, and the V-sealing 508, the sealing collar 509 and the V-sealing 508 are also fitted around and coupled to the lamp socket fixing handle 503 in this order. In addition, the lamp base socket housing 511 is fitted around and coupled to the lamp socket fixing handle 503, and the UV lamp socket 513 is provided inside the lamp base socket housing 511.

In addition, for coupling the quartz tube end portion, an end 411 of a ‘⊥’-shaped quartz tube 410 is coupled to an X-ring 630, and the X-ring 630 is coupled to a sleeve support 610. Moreover, an O-ring 660 is fitted around the sleeve support 610, and an end doom cab 620 is also fitted thereon. In addition, an air outlet 650 is provided at one side of the end doom cab 620 to exhaust air in the end socket, thereby ensuring secure coupling. In addition, in the quartz tube assembled as above, the quartz tube socket bracket 488 coupled to the side support 486 is interposed between the O-ring 505 and the frame clamp nut 506 and installed at the side support 486, and the end bracket 487 coupled to the side support 485 is interposed between the sleeve support 610 and the end doom cab 620 and installed at the side support 485.

In the conventional open channel-type UV disinfection system configured as above, a bottom guide rail is located between lower bases of the side support, and thus a dead zone is generated during UV irradiation. In addition, in the conventional open channel-type UV disinfection system configured as above, after the lamp quartz tube is assembled, the UV lamp may be separated from the lamp socket due to vibration caused by running water or vibration caused by the cleaning module, which may result in electric short and inferior UV disinfection. In addition, in the conventional open channel-type UV disinfection system described as above, the sleeve support and the end doom cab are fixed to a frame made of steel, a single X-ring made of rubber offsets vibration and impact transferred to the quartz tube, and a distance between one side support and the other side support is 1 m or above. For this reason, if one side support and the other side support are not aligned straightly, a serious gap may be generated between their levels even by a minute angle difference, which applies a bending moment to the quartz sleeve and thus results in breakdown or deviation of the quartz tube or inferior UV irradiation. In addition, in the conventional open channel-type UV disinfection system configured as above, the V-sealing may be distorted due to the rotation applied when assembling the socket.

### SUMMARY OF THE INVENTION

Accordingly, embodiments in accordance with the present invention are conceived to address the above concerns. The embodiments of the present invention are to provide an open channel-type UV disinfection system capable of preventing generation of a dead zone and breakdown of a quartz tube socket, in which a dead zone is minimized in the open channel-type UV disinfection system and the quartz tube and the socket are stably installed and maintained to ensure efficient UV sterilization.

In order to address the above concerns of the above conventional technique, embodiments of the present invention are to provide a quartz tube socket applied to the open channel-type UV disinfection system for preventing generation of a dead zone, in which a location of a bottom guide rail is moved to an upper portion of the bottom base to eliminate a sterilization dead zone, a ceramic base at one end of the quartz tube lamp is formed to have a ‘⊥’ shape and a compression spring is fitted therearound to prevent the quartz tube lamp from being shaken due to vibrations and thus prevents a power connection from being disconnected, and rings made of rubber are interposed between the sleeve support of the quartz tube lamp and the frame and between the end doom cab and the frame to prevent a bending moment from being applied to the quartz tube. In addition, the present invention prevents the V-sealing from being distorted due to rotation, by attaching a backup ring to each V-sealing when the quartz tube socket is assembled.

According to an embodiment of the present invention for achieving the objects, there is provided a quartz tube socket, which is mounted to an open channel-type UV disinfection system, is coupled to a quartz tube having one end portion, and has one side coupled to an electric cable end. The quartz tube socket includes a lamp socket fixing handle coupled to the electric cable end at the other side thereof; a sealing fixture fitted around and coupled to the lamp socket fixing handle, an O-ring fitted around the sealing fixture; a frame clamp nut fitted after the O-ring; a sleeve stopper fitted after the frame clamp nut; an O-ring fitted after the sleeve stopper; a V-sealing fitted around the sealing fixture; a backup ring installed after the V-sealing; a sealing collar installed after the backup ring; a V-sealing fitted after the sealing collar; a backup ring fitted and installed after the V-sealing; and a lamp base socket housing fitted around and coupled to the lamp socket fixing handle.

### BRIEF DESCRIPTION OF THE DRAWINGS

FIG. 1 is a perspective view showing a conventional open channel-type UV disinfection system;

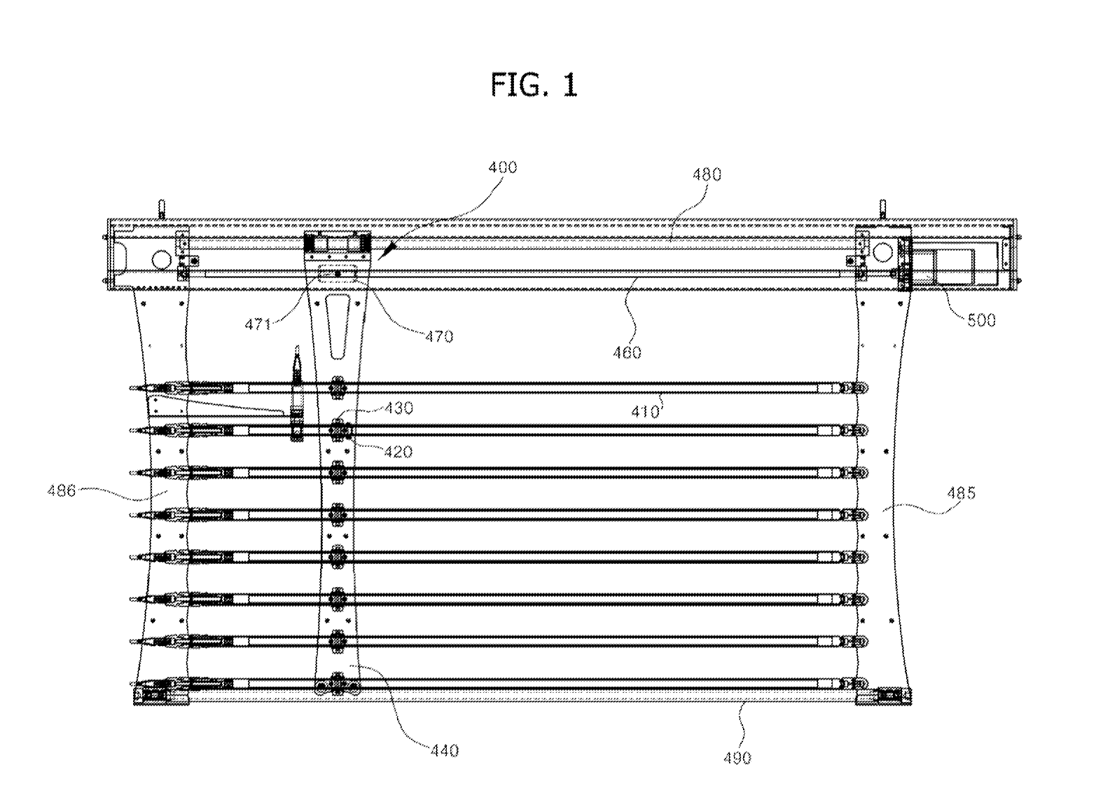

FIG. 2 (a) is an assembled cross-sectional view showing a quartz tube socket applied to the conventional open channel-type UV disinfection system;

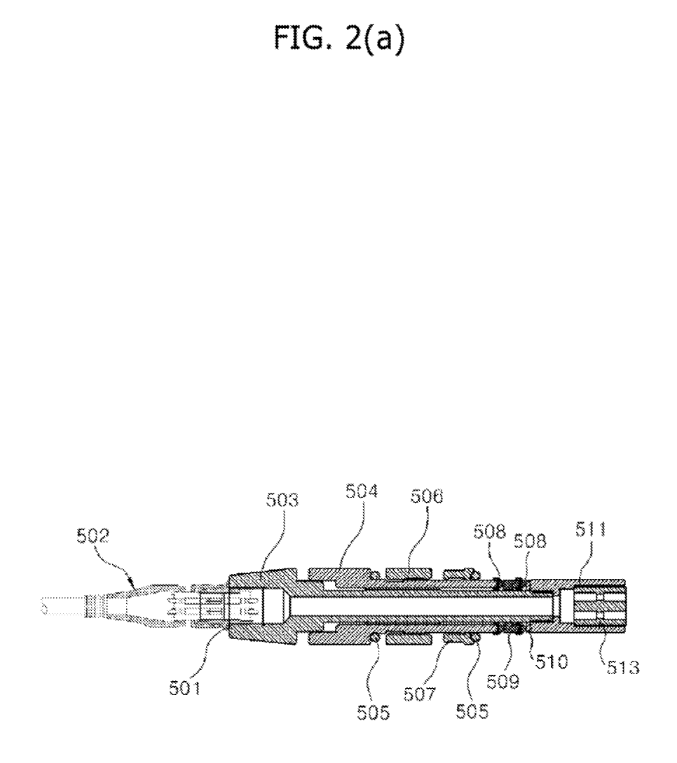

FIG. 2 (b) is an exploded view showing the quartz tube socket applied to the conventional open channel-type UV disinfection system;

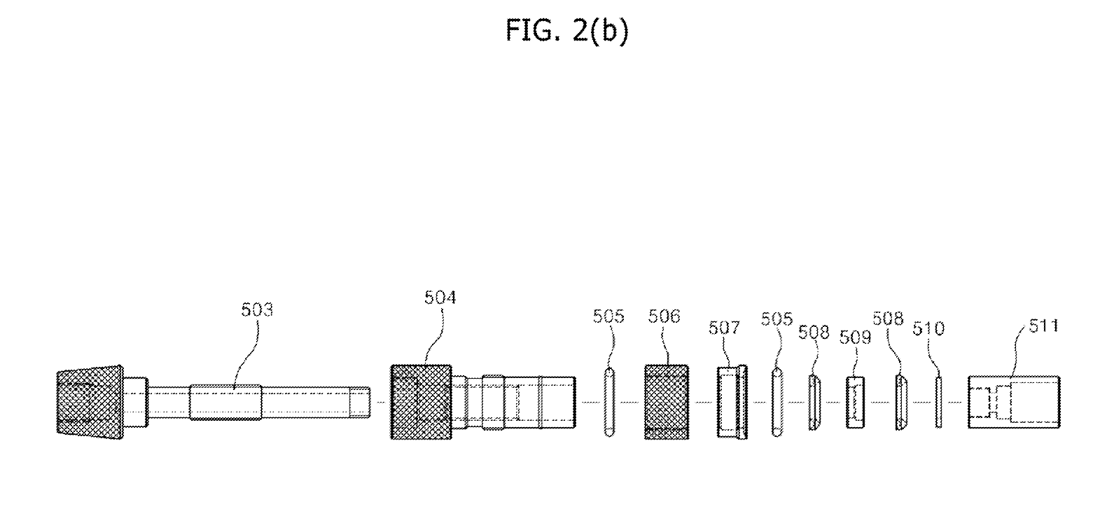

FIG. 3 is a cross-sectional view showing a quartz tube body applied to the conventional open channel-type UV disinfection system;

FIG. 4 is a perspective view showing an open channel-type UV disinfection system according to the present invention for preventing generation of a dead zone and breakdown of the quartz tube socket;

FIG. 5 is a partial side view showing portion A of FIG. 4;

FIG. 6 is a partial side view showing portion C of FIG. 4;

FIG. 7 (a) is an assembled cross-sectional view showing a quartz tube socket applied to the present invention;

FIG. 7 (b) is an exploded view showing the quartz tube socket applied to the present invention;

FIG. 8 is an assembled perspective view showing the quartz tube socket applied to the present invention;

FIG. 9 (a) is an exploded view showing a first embodiment of a quartz tube end portion applied to the present invention;

FIG. 9 (b) is an assembled cross-sectional view showing the first embodiment of the quartz tube end portion applied to the present invention;

FIG. 10 is a cross-sectional view showing an end doom cab coupled to the quartz tube, the quartz tube socket and the quartz tube end portion;

FIG. 11 is a detailed exploded view showing the first embodiment of the quartz tube end portion applied to the present invention;

FIG. 12 is an exploded view showing a second embodiment of the quartz tube end portion applied to the present invention;

FIG. 13 is an assembled cross-sectional view showing the second embodiment of the quartz tube end portion applied to the present invention; and

FIG. 14 shows a front view and a partially enlarged view showing the quartz tube end portion applied to the present invention, which is installed at a side support of the UV disinfection system.

### DETAILED DESCRIPTION OF THE PREFERRED EMBODIMENT

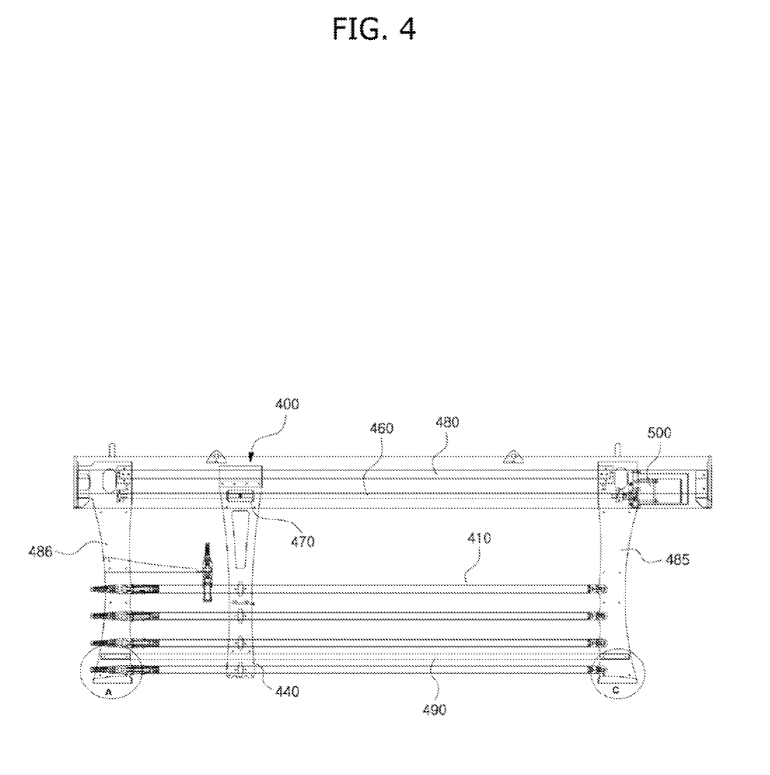

An open channel-type UV disinfection system according to the present invention for preventing generation of a dead zone and breakdown of a quartz tube socket will be described below with reference to FIGS. 4 to 14.

FIG. 4 is a perspective view showing an open channel-type UV disinfection system according to the present invention for preventing generation of a dead zone and breakdown of the quartz tube socket. In FIG. 4, an open channel-type UV disinfection system according to the present invention for preventing generation of a dead zone and breakdown of a quartz tube socket includes a plurality of ‘⊂’-shaped wiper ring brackets at both sides of a wiper frame 440 of a quartz tube cleaning system 400. A wiper ring is inserted into and supported by the ‘⊂’-shaped wiper bracket. Here, the ‘⊂’-shaped wiper ring bracket is coupled to the wiper frame 440 having an H shape and supported by a plurality of coupling units using bolts and nuts. Holes are formed in upper and lower portions of the wiper ring bracket so that upper and lower sides of the wiper ring may be inserted therein. In the open channel-type UV disinfection system for preventing generation of a dead zone and breakdown of the quartz tube socket as configured above, since a quartz tube 410 may be easily attached to or detached from a side of the UV disinfection system, the quartz tube 410 may be easily maintained and repaired. In addition, the quartz tube cleaning system 400 employs a motor, and as a motor 500 rotates clockwise or counterclockwise, a drive screw 460 linked to the motor rotates clockwise or counterclockwise. In addition, as the drive screw 460 rotates clockwise or counterclockwise, a drive nut 470 moves the cleaning system from side to side in a length direction of the quartz tube. Moreover, a top guide rail 480 and a bottom guide rail 490 are provided at the UV disinfection system to guide the quartz tube cleaning system. In addition, the top guide rail 480 is installed at the upper portion of the UV disinfection system and the bottom guide rail 490 is provided at a location higher than the quartz tube socket at the lowermost position so as to be fixedly coupled to side supports 485 and 486 at both ends. As the motor 500 rotates, the drive screw 460 connected to the motor using a coupling unit also rotates, and the rotation of the drive screw 460 causes the drive nut 470 to move from side to side and the wiper ring 420 installed at the wiper frame to clean the quartz tube 410. In order to prevent vibration, deviation from a track or the like, when the cleaning system 400 moves from side to side by means of the drive nut 470 as described above, the top guide rail 480 and the bottom guide rail 490 are provided at the upper and lower portions, thereby guiding the cleaning system from side to side. In the above, since the bottom guide rail 490 is provided at the location higher than the quartz tube socket at the lowermost location, it is possible to prevent a UV disinfection dead zone from being generated by the bottom guide rail.

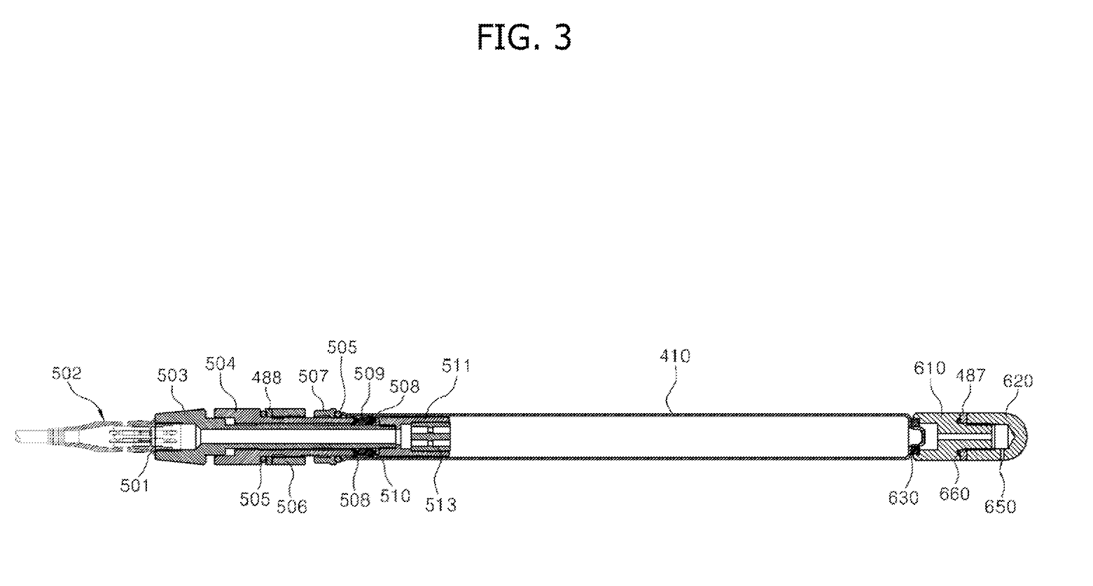

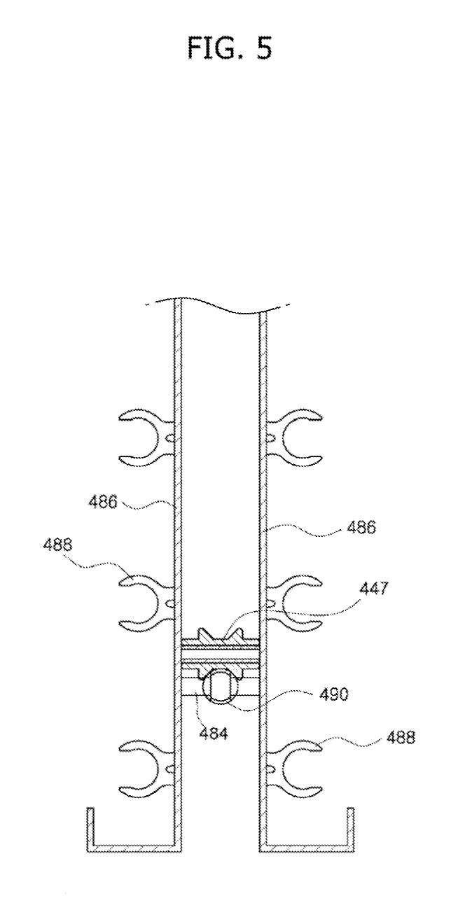

FIG. 5 is a partial side view showing portion A of FIG. 4. In FIG. 5, the side support 486 of the UV disinfection system includes a plurality of quartz tube socket brackets 488. A bottom guide rail 490 and a fixture member 484 for fixedly connecting the bottom guide rail 490 and the side support 486 are installed at the lower portion of the side support so that the bottom guide rail 490 is fixed to the side support 486. In addition, in FIG. 3, since the quartz tube socket bracket 488 is interposed between an O-ring 505 of the quartz tube socket and a frame clamp nut 506, the quartz tube socket is fixed to the side support 486. A bottom roller 447 surrounding the bottom guide rail 490 is attached to the wiper frame 440 using bolts and nuts and is slidable on the bottom guide rail 490.

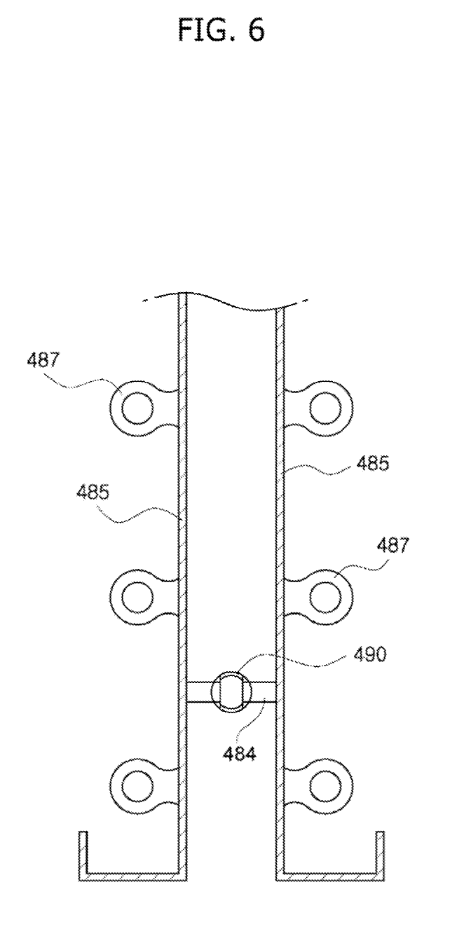

FIG. 6 is a partial side view showing portion C of FIG. 4. In FIG. 6, a plurality of end brackets 487 are provided at the side support 485 of the UV disinfection system. The bottom guide rail 490 is installed at a location higher than the lowermost end bracket of the side support 485. Also, the bottom guide rail 490 is fixed to the side support 485 using the fixture member 484. In addition, in FIG. 4, the end bracket 487 is interposed between a sleeve support 610 of the quartz tube end portion and an end doom cab 620, so that the quartz tube end portion is fixed to the side support 485.

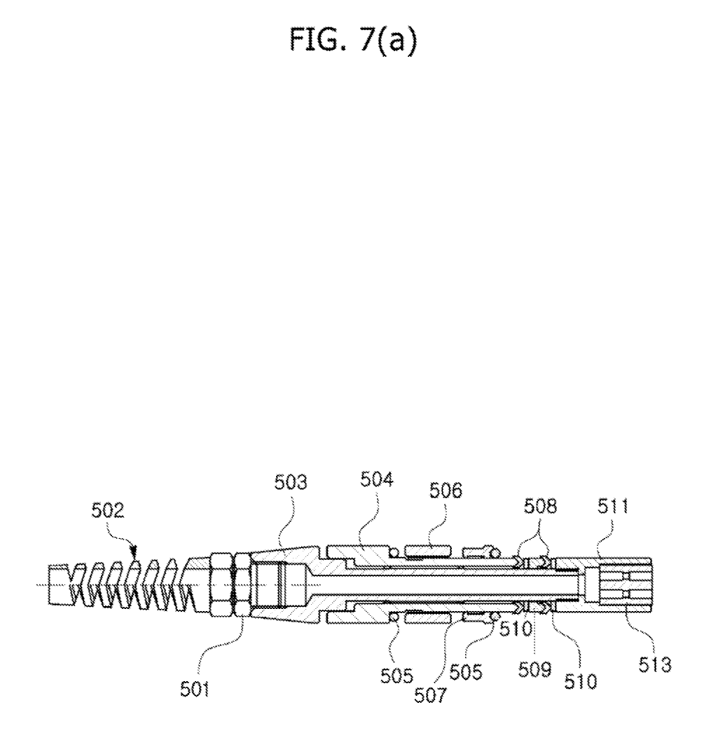

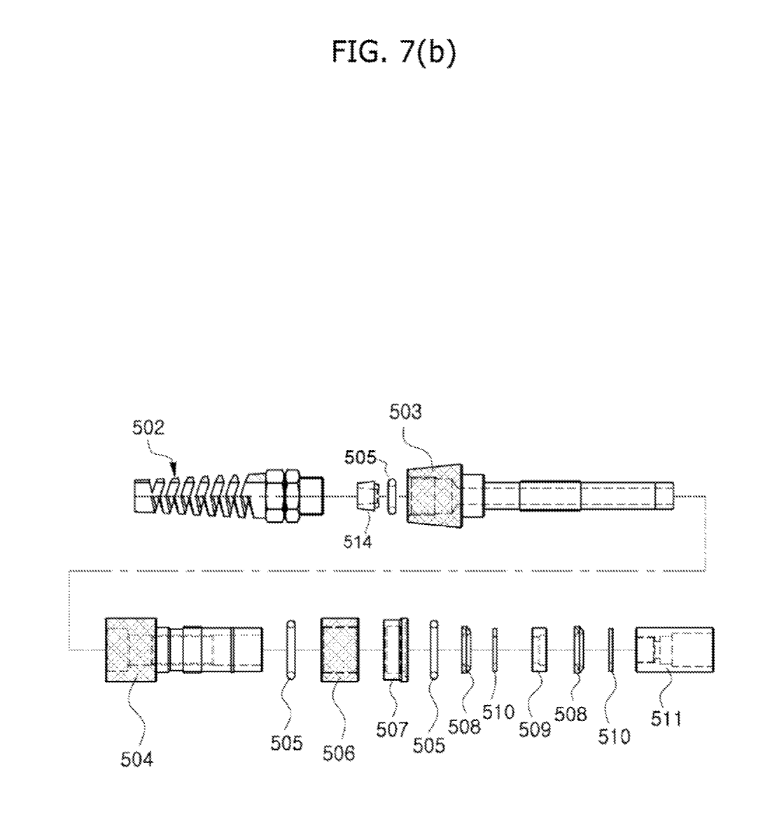

FIG. 7 (a) is an assembled cross-sectional view showing the quartz tube socket applied to the present invention. In FIG. 7 (a), in the quartz tube socket applied to the present invention, a cable end 502 with a cable sealing 514 provided therein is coupled to a lamp socket fixing handle 503. In addition, a sealing fixture 504 is fitted around and coupled to the lamp socket fixing handle 503, and an O-ring 505, a frame clamp nut 506 and a sleeve stopper 507 are fitted around and coupled to the sealing fixture 504. Moreover, the O-ring 505 is installed and coupled to one side end of the sleeve stopper 507, and a V-sealing 508, a backup ring 510, a sealing collar 509, a V-sealing 508 and a backup ring 510 are also installed and coupled to one side end of the sealing fixture 504 in this order. In addition, a lamp base socket housing 511 is fitted around and coupled to the lamp socket fixing handle 503, and a UV lamp socket 513 is provided inside the lamp base socket housing 511. Moreover, a quartz tube socket bracket 488 provided at the side support 486 is interposed between the O-ring 505 and the fixing clamp nut 506.

FIG. 7 (b) is an exploded view showing the quartz tube socket applied to the present invention. FIG. 7 (b) shows that the O-ring 505, the lamp socket fixing handle 503, the sealing fixture 504, the frame clamp nut 506, the sleeve stopper 507, the O-ring 505, the V-sealing 508, the backup ring 510, the sealing collar 509, the V-sealing 508, the backup ring 510, the lamp base socket housing 511 and the like are exploded.

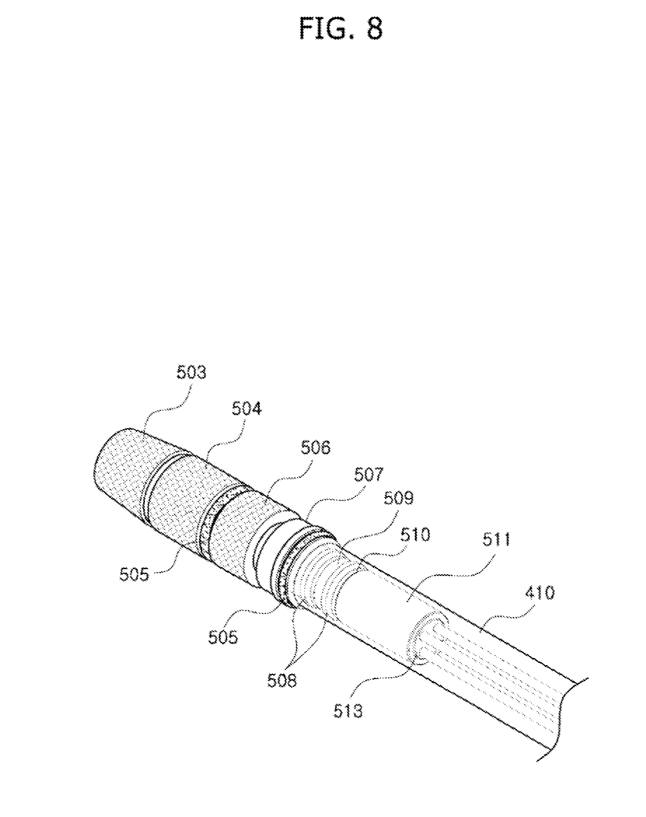

FIG. 8 is an assembled perspective view showing the quartz tube socket applied to the present invention. In FIG. 8, the sealing fixture 504 is fitted around and coupled to the lamp socket fixing handle 503, and the O-ring 505, the frame clamp nut 506 and the sleeve stopper 507 are fitted around and coupled to the sealing fixture 504. In addition, the O-ring 505 is installed and coupled to the one end of the sleeve stopper 507. Then, the V-sealing 508, the backup ring 510, the sealing collar 509, the V-sealing 508 and the backup ring 510 are also installed and coupled to the one side end of the sealing fixture 504 in this order. In addition, the lamp base socket housing 511 is fitted around and coupled to the end of the lamp socket fixing handle 503, and a UV lamp socket 513 is provided in the lamp base socket housing 511. If the quartz tube is fitted around the socket according to the present invention as described above, the quartz tube and the quartz tube socket may be simply manually coupled without using any additional tool, thereby ensuring easy assembling. In addition, the assembling process may be checked by naked eyes, and distortion of the V-sealing caused when the socket is coupled may be prevented, thereby decreasing breakdown of the quartz tube.

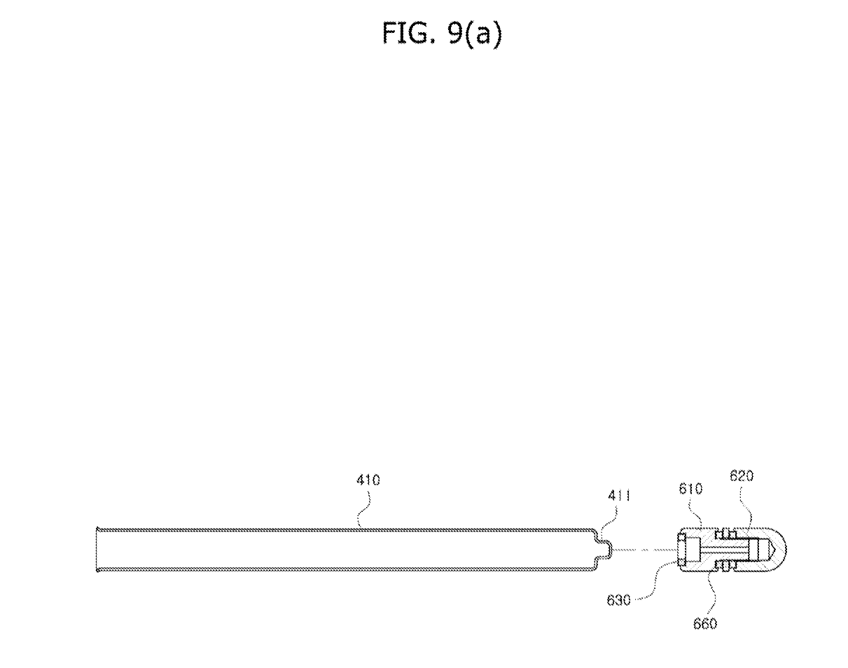

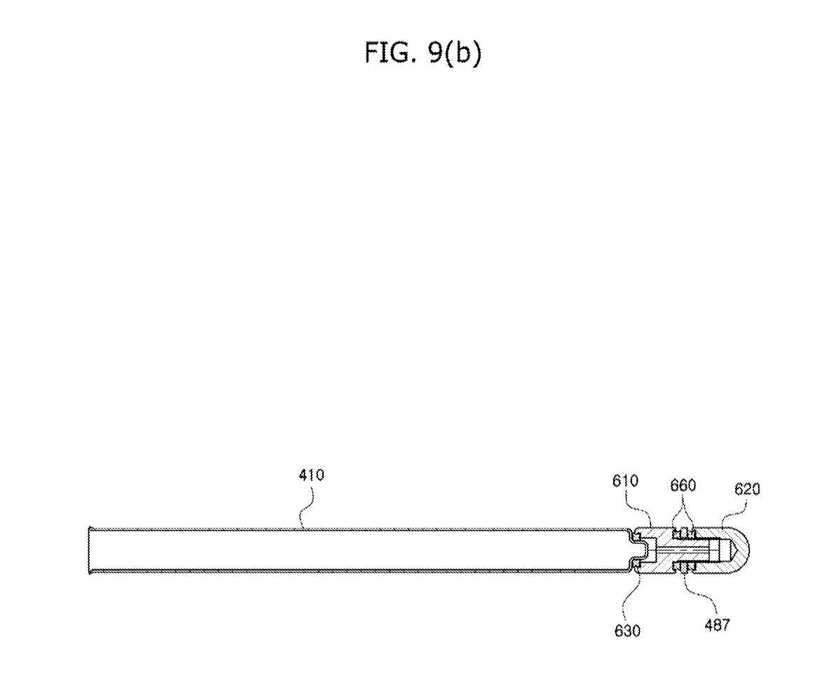

FIG. 9 (a) is an exploded view showing a first embodiment of the quartz tube end portion applied to the present invention. In FIG. 9 (a), the ‘⊥’-shaped quartz tube end portion 411, which is one end of the quartz tube, is coupled to an X-ring 630, and the X-ring 630 is coupled to the sleeve support 610. In addition, the sleeve support 610 is coupled to the end doom cab 620, and an X-ring 660, an end bracket 487 and an X-ring 660 may be coupled between the sleeve support 610 and the end doom cab 620 in this order.

FIG. 9 (b) is an assembled cross-sectional view showing the first embodiment of the quartz tube end portion applied to the present invention. In FIG. 9 (b), the ‘⊥’-shaped quartz tube end portion 411, which is one end of the quartz tube, is coupled to the X-ring 630, and the X-ring 630 is coupled to the sleeve support 610. In addition, the sleeve support 610 is coupled to the end doom cab 620, and the X-ring 660, the end bracket 487 and the X-ring 660 may be coupled between the sleeve support 610 and the end doom cab 620 in this order.

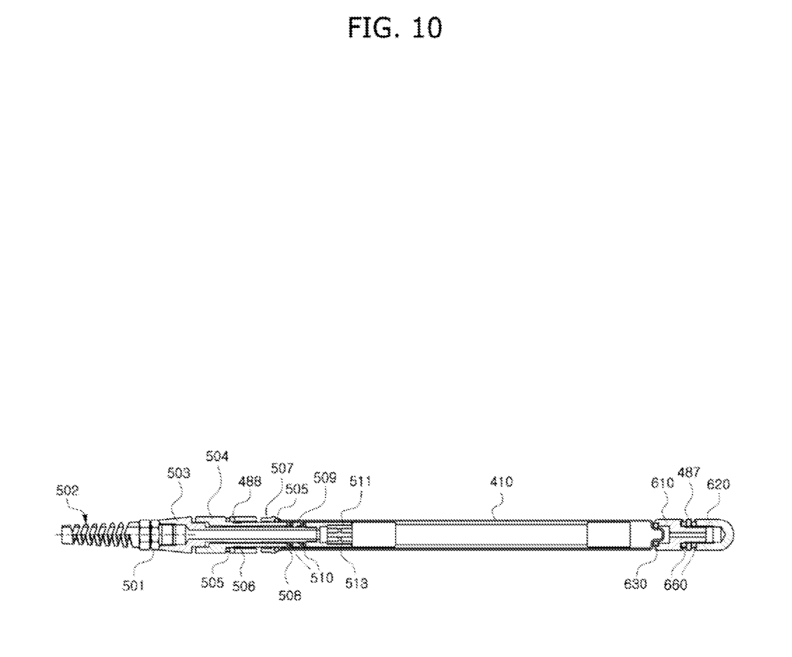

FIG. 10 is a cross-sectional view showing the end doom cab 620 coupled to the quartz tube, the quartz tube socket and the quartz tube end portion. In FIG. 10, the cable end 502 with the cable sealing 514 provided therein is coupled to the lamp socket fixing handle 503. The sealing fixture 504 is fitted around and coupled to the lamp socket fixing handle 503. In addition, the O-ring 505, the frame clamp nut 506 and the sleeve stopper 507 are fitted around and coupled to the sealing fixture 504. Moreover, the O-ring 505 is fitted around and coupled to the sealing fixture 504 at its end, and the V-sealing 508, the backup ring 510, the sealing collar 509, the V-sealing 508 and the backup ring 510 are also fitted around and coupled to the lamp socket fixing handle 503 at its end in this order. In addition, the lamp base socket housing 511 is fitted around and coupled to one end of the lamp socket fixing handle 503, and the lamp base socket housing 511 has a UV lamp socket 513 provided therein. Moreover, for the coupling of the quartz tube end portion, the end 411 of the ‘⊥’-shaped quartz tube 410 is coupled to the X-ring 630, and the X-ring 630 is coupled to the sleeve support 610. Moreover, the sleeve support 610 is coupled to the end doom cab 620, and the X-ring 660, an end bracket 487 and the X-ring 660 are interposed and coupled between the sleeve support 610 and the end doom cab 620 in this order. In addition, in the quartz tube assembled as above, the quartz tube socket bracket 488 coupled to the side support 486 is interposed between the O-ring 505 and the frame clamp nut 506 and installed at the side support 486, and the end bracket 487 coupled to the side support 485 is interposed between the sleeve support 610 and the end doom cab 620 and installed at the side support 485.

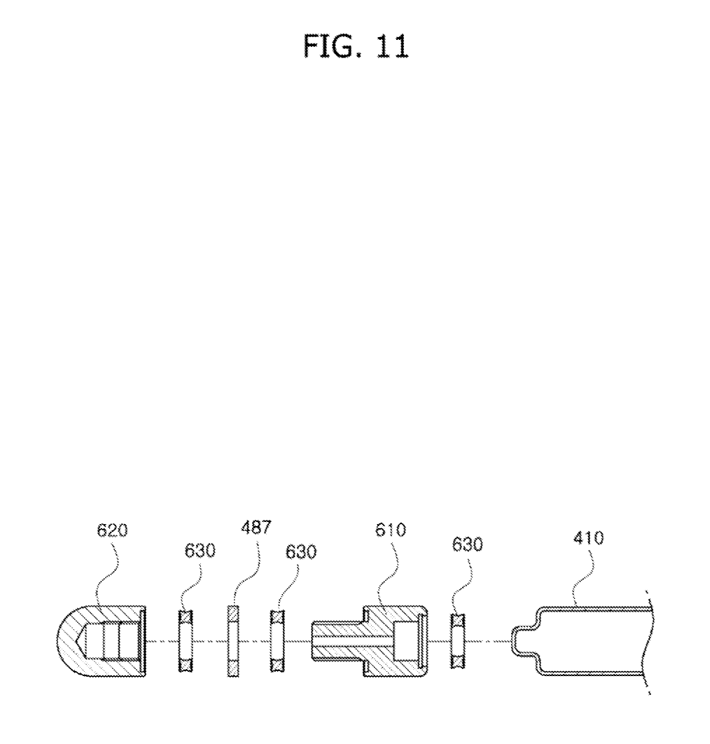

FIG. 11 is a detailed exploded view showing the first embodiment of the quartz tube end portion applied to the present invention. In FIG. 11, the first embodiment of the quartz tube end portion applied to the present invention includes the end 411 of the ‘⊥’-shaped quartz tube 410, the X-ring 630 fitted around and coupled to the ‘⊥’-shaped quartz tube end portion, the sleeve support 610 coupled to the X-ring 630, the end doom cab 620 coupled to the sleeve support 610, the X-ring 660 interposed and coupled between the sleeve support 610 and the end doom cab, the end bracket 487 fitted and coupled after the X-ring, and the X-ring 660 fitted and coupled after the end bracket.

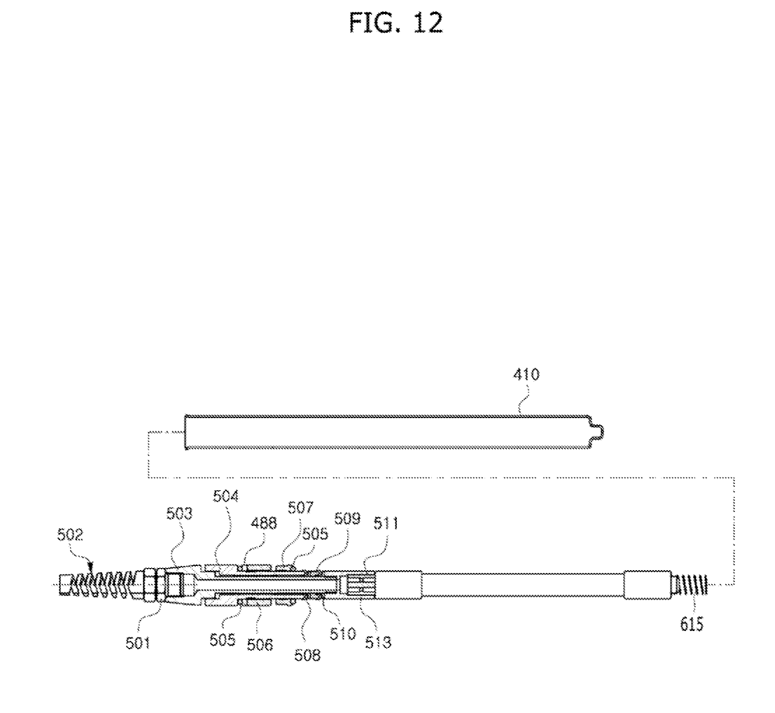

FIG. 12 is an exploded view showing a second embodiment of the quartz tube end portion applied to the present invention. In FIG. 12, according to the second embodiment of the quartz tube end portion applied to the present invention, a connection terminal ceramic base at one side of the lamp has a ‘⊥’ shape, and a compression spring is fitted around the ‘⊥’ shape portion. In addition, the ceramic base where the compression spring is fitted and installed is inserted and installed into the ‘⊥’-shaped quartz tube end portion in order to solve the problem that the lamp is disconnected from a power connection due to vibration and thus does not turn on.

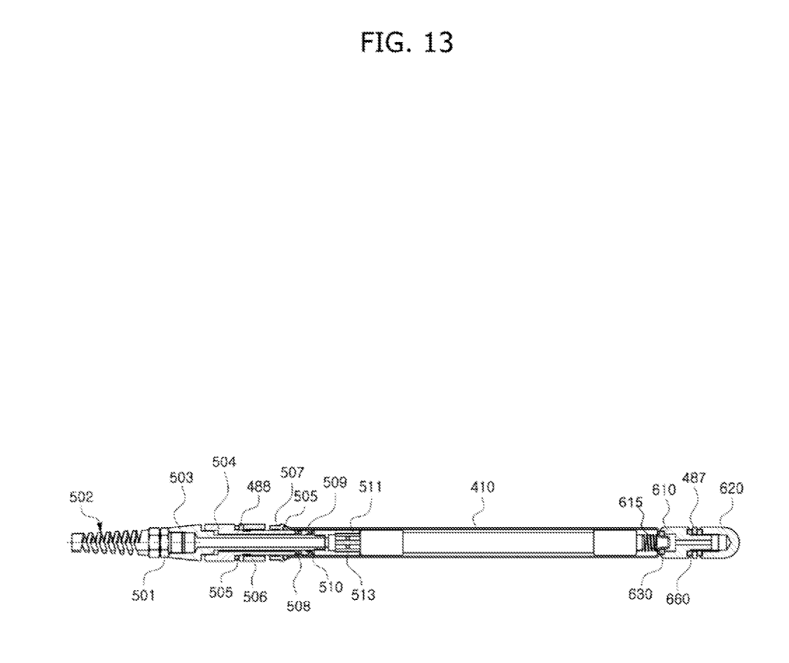

FIG. 13 is an assembled cross-sectional view showing the second embodiment of the quartz tube end portion applied to the present invention. In FIG. 13, the second embodiment of the quartz tube end portion applied to the present invention includes a lamp one-side connection terminal made of ceramic in a ‘⊥’ shape and inserted and installed into the quartz tube end portion, a compression spring 615 fitted around the ‘⊥’-shaped connection terminal, the end 411 of the ‘⊥’-shaped quartz tube 410, the X-ring 630 fitted around the ‘⊥’-shaped quartz tube end portion, the sleeve support 610 coupled to the X-ring 630, the end doom cab 620 coupled to the sleeve support 610, the X-ring 660 interposed and coupled between the sleeve support 610 and the end doom cab, the end bracket 487 coupled after the X-ring, and the X-ring 660 coupled after the end bracket.

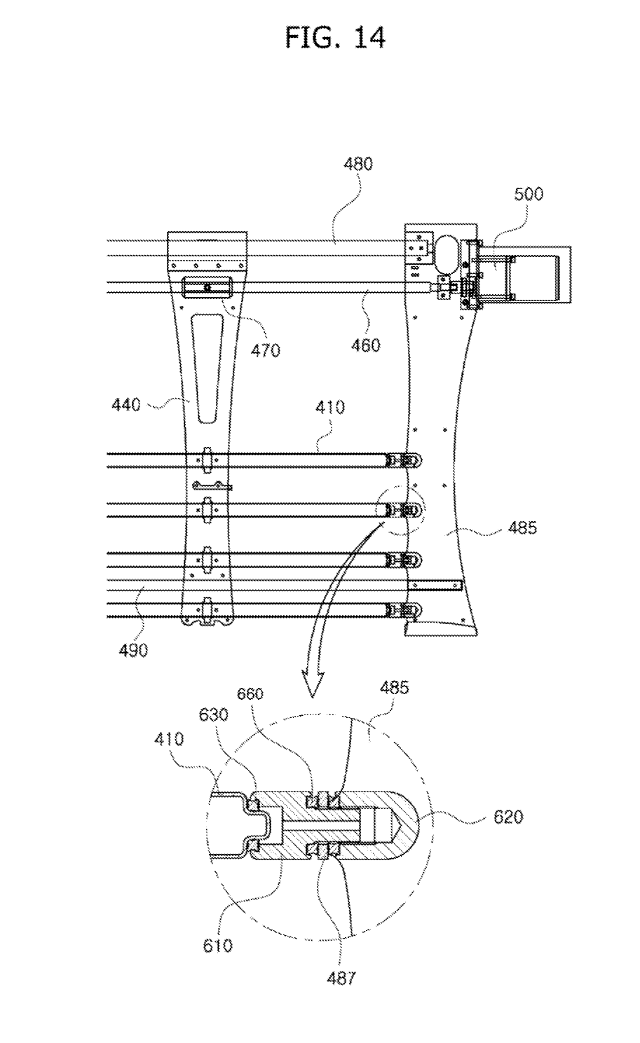

FIG. 14 shows a front view and a partially enlarged view showing the quartz tube end portion applied to the present invention, which is installed at a side support of the UV disinfection system. In FIG. 14, at one side of the quartz tube, the end bracket 487 formed at the side support 485 is inserted in a gap formed between the sleeve support 610 at one side of the quartz tube and the end doom cab 620, thereby being fixed to the support.

According to the present invention configured as above, it is possible to solve insufficient UV sterilization in a channel by eliminating a UV disinfection dead zone generated by a bottom guide rail. Further, according to the present invention, by using a spring mounted to the quartz tube lamp, it is possible to prevent UV sterilization from being interrupted due to an electric short caused by vibration of the quartz tube lamp or the quartz tube. Moreover, in the present invention, a bending moment of the quartz tube may be prevented by the rubber ring, the V-sealing and the O-ring between the sleeve support and the end bracket and between the end doom cab and the end bracket. Furthermore, distortion of the V-sealing caused when the socket is coupled may be prevented, thereby allowing the quartz tube lamp to be stably mounted to the socket.

What is claimed is:

1. A quartz tube socket mounted to an open channel-type UV disinfection system and coupled to a quartz tube having one end portion, the quartz tube socket having one side coupled to an electric cable end, the quartz tube socket comprising:
a lamp socket fixing handle coupled to the electric cable end at the other side of the quartz tube socket;
a sealing fixture fitted around and coupled to one side of the lamp socket fixing handle;
an O-ring fitted around the sealing fixture;
a frame clamp nut fitted around the sealing fixture after the O-ring;
a sleeve stopper fitted around the sealing fixture after the frame clamp nut;
an O-ring fitted around the sealing fixture after the sleeve stopper;
a V-sealing installed at one side end of the sealing fixture;
a sealing collar fitted around the lamp socket fixing handle after the backup ring;
a V-sealing fitted around the lamp socket fixing handle after the sealing collar;
a backup ring fitted around the lamp socket fixing handle after the V-sealing; and
a lamp base socket housing fitted around and coupled to an end of the lamp socket fixing handle.

2. The quartz tube socket according to claim 1, wherein the one end portion of the quartz tube further includes:
an end of the quartz tube;
an X-ring fitted around and coupled to the end portion of the quartz tube;
a sleeve support coupled to the X-ring;
an end doom cab coupled to the sleeve support;
an X-ring interposed and coupled between the sleeve support and the end doom cab;
an end bracket fitted and coupled after the X-ring; and
an X-ring fitted and coupled after the end bracket.

3. The quartz tube socket according to claim 2, wherein the one end portion of the quartz tube further includes:
a lamp one-side connection terminal inserted and installed into the end portion of the quartz tube; and
a compression spring fitted around the lamp one-side connection terminal.

4. The quartz tube socket according to claim 1, wherein the end portion of the quartz tube has a ‘⊥’ shape having a protruding center.

5. An open channel-type UV disinfection system having a quartz tube socket, the system comprising:
a drive screw configured to rotate in association with a shaft of a motor;
a drive nut configured to move from side to side by the drive screw;
a quartz tube cleaning system connected to the drive nut to clean the quartz tube installed at an ‘H’-shaped wiper frame;
‘H’-shaped side supports configured to support the quartz tube cleaning system, the motor, the drive screw and the quartz tube at both sides;
a top guide rail installed at an upper portion of the side support and the side support; and
a bottom guide rail installed at a lower portion of the side support and the side support to be located higher than a lowest position of the quartz tube socket.

6. The open channel-type UV disinfection system according to claim 5, wherein the quartz tube socket comprising:
a lamp socket fixing handle coupled to the electric cable end at the other side of the quartz tube socket;
a sealing fixture fitted around and coupled to one side of the lamp socket fixing handle;
an O-ring fitted around the sealing fixture;
a frame clamp nut fitted around the sealing fixture after the O-ring;
a sleeve stopper fitted around the sealing fixture after the frame clamp nut;
an O-ring fitted around the sealing fixture after the sleeve stopper;
a V-sealing installed at one side end of the sealing fixture;
a sealing collar fitted around the lamp socket fixing handle after the backup ring;
a V-sealing fitted around the lamp socket fixing handle after the sealing collar;
a backup ring fitted around the lamp socket fixing handle after the V-sealing; and
a lamp base socket housing fitted around and coupled to an end of the lamp socket fixing handle.

7. The open channel-type UV disinfection system according to claim 6, wherein the one end portion of the quartz tube further includes:
an end of the quartz tube;
an X-ring fitted around and coupled to the end portion of the quartz tube;
a sleeve support coupled to the X-ring;
an end doom cab coupled to the sleeve support;
an X-ring interposed and coupled between the sleeve support and the end doom cab;
an end bracket fitted and coupled after the X-ring; and
an X-ring fitted and coupled after the end bracket.

8. The open channel-type UV disinfection system according to claim 7, wherein the one end portion of the quartz tube further includes:
a lamp one-side connection terminal inserted and installed into the end portion of the quartz tube; and
a compression spring fitted around the lamp one-side connection terminal.

9. The open channel-type UV disinfection system according to claim 6, wherein the end portion of the quartz tube has a ‘⊥’ shape having a protruding center.

10. The open channel-type UV disinfection system according to claim 7, wherein the end portion of the quartz tube has a ‘⊥’ shape having a protruding center.
